(19) United States
(12) Patent Application Publication
(10) Pub. No.: US 2026/0253001 A1
(43) Pub. Date: Aug. 27, 2026

(54) OPERATION MONITORING DEVICE, OPERATION MONITORING SYSTEM, AND METHOD

(71) Applicant: NEC Corporation, Tokyo (JP)

(72) Inventor: Mitsuru Morikawa, Tokyo (JP)

(73) Assignee: NEC Corporation, Tokyo (JP)

(21) Appl. No.: 19/541,738

(22) Filed: Feb. 17, 2026

(30) Foreign Application Priority Data
Feb. 25, 2025 (JP) 2025-027502

(51) Int. Cl. G06Q 10/0633

(52) U.S. Cl. CPC G06Q 10/0633

(57) ABSTRACT

An object of the present disclosure is to provide an operation monitoring device, an operation monitoring system, a method, and a program capable of quickly recovering a facility of another company even in a case where a device of the facility of the another company fails in a network including a facility of an own company and the facility of the another company. An operation monitoring device according to the present disclosure includes a monitoring unit for monitoring an operation of a network including a facility of an own company and a facility of another company, an acquisition unit for acquiring location attribute information of the facility, the location attribute information including at least an attribute indicating a facility manager of the facility, and a determination unit for determining a measure for recovering the facility in a case where a failure occurs in the facility.

### SPECIFICATION

### INCORPORATION BY REFERENCE

This application is based upon and claims the benefit of priority from Japanese patent application No. 2025-027502, filed on February 25, 2025, the disclosure of which is incorporated herein in its entirety by reference.

### TECHNICAL FIELD

The present disclosure relates to operation monitoring devices, operation monitoring systems, methods, and programs, and more particularly, to an operation monitoring device, an operation monitoring system, a method, and a program capable of quickly recovering a facility of another company even in a case where a device of the facility of the another company fails in a network including a facility of the own company and the facility of the another company.

### BACKGROUND ART

Data center business of communication carriers is expanding due to spread of cloud services, progress of Artificial Intelligence (AI), demand expansion of big data and/or acceleration of Digital transformation (DX).

On the other hand, since capital investment tends to be suppressed due to slow growth of communication revenue and the like, cost reduction and management efficiency improvement are implemented using existing facilities of other companies, data centers of other companies, and the like. Therefore, it is predicted that the communication carrier provides services by using not only the facilities of the communication carrier itself (own company) but also facilities, data centers, and the like of other companies. As a result, the communication carrier needs to construct and manage a network by using not only the facilities owned by the company but also the facilities of other companies.

JP 2020-140522 A discloses “A failure analysis support device that stores failure diagnosis tree information that is information indicating a structure of a failure diagnosis tree, event occurrence rate information that is information indicating an occurrence rate of each event constituting the failure diagnosis tree, diagnosis cost information that is information indicating a cost required for diagnosis of each event, and movement cost information that is information indicating a cost required for movement to a place where diagnosis is performed, selects an optimal diagnosis path tree that is a diagnosis path tree indicating a work procedure that minimizes a sum of costs required to specify a root cause of a failure based on the failure diagnosis tree information, the event occurrence rate information, the diagnosis cost information, and the movement cost information, and generates support information that is information to be presented at the time a worker performs diagnosis along the optimal diagnosis path tree”. JP 2020-140522 A does not disclose “an operation monitoring device, an operation monitoring system, a method, and a program capable of quickly recovering a facility of another company even in a case where a device of the facility of the another company fails in a network including a facility of the own company and the facility of the another company”.

JP 2013-141122 A discloses a “failure segmentation procedure generation device that generates a failure segmentation procedure for specifying a failure location of a network, the failure segmentation procedure generation device including a device attribute storage means for storing a failure probability and an inspection work cost according to a time slot for each device constituting the network, an inter-device movement cost storage means for storing a movement cost required for movement between devices, and a procedure generation means for generating a failure segmentation procedure that minimizes an expected value of a total work cost estimated to be necessary until a failed device in the network is specified, in which the procedure generation means calculates the expected value of the total work cost using the movement cost, the inspection work cost, and the failure probability”. JP 2013-141122 A does not disclose “an operation

monitoring device, an operation monitoring system, a method, and a program capable of quickly recovering a facility of another company even in a case where a device of the facility of the another company fails in a network including a facility of the own company and the facility of the another company”.

### SUMMARY

In a communication carrier monitoring business, in a case where a failure occurs in a device (e.g., an optical transmission device) and a service is affected, it is desirable to reduce an Operating Expense (OPEX) required for improvement of service quality and recovery work by quickly determining and executing a measure for service recovery. However, in a case where the optical transmission device managed by the communication carrier is installed in a facility of another company, there is a problem that a maintenance staff member of the communication carrier cannot immediately enter the facility at the time the optical transmission device fails, and it takes time to perform the recovery work such as replacement of the optical transmission device.

In order to solve the above-described problems, an example object of the present disclosure is to provide an operation monitoring device, an operation monitoring system, a method, and a program capable of quickly recovering a facility of another company even in a case where a device of the facility of the another company fails in a network including a facility of an own company and the facility of the another company.

An operation monitoring device according to an example aspect of the present disclosure includes a monitoring unit for monitoring an operation of a network including a facility of an own company and a facility of another company, an acquisition unit for acquiring location attribute information of the facility, the location attribute information including at least an attribute indicating a facility manager of the facility, and a determination unit for determining a measure for recovering the facility based on the location attribute information in a case where a failure occurs in the facility.

An operation monitoring system according to an example aspect of the present disclosure includes a facility of an own company, a facility of another company, and an operation monitoring device, in which the facility of the own company includes at least one or more devices for communication, the facility of the another company includes at least one or more of the devices for communication, the device in the facility of the own company and the device in the facility of the another company communicate with each other, and the operation monitoring device includes, a monitoring unit for monitoring an operation of a network including the facility of the own company and the facility of the another company, an acquisition unit for acquiring location attribute information of the facility, the location attribute information including at least an attribute indicating a facility manager of the facility, and a determination unit for determining a measure for recovering the facility based on the location attribute information in a case where a failure occurs in the facility.

A method according to an example aspect of the present disclosure is a method executed by an operation monitoring device, the method including, monitoring an operation of a network including a facility of an own company and a facility of another company, acquiring location attribute information of the facility, the location attribute information including at least an attribute indicating a facility manager of the facility, and determining a measure for recovering the facility based on the location attribute information in a case where a failure occurs in the facility. A program according to an example aspect of the present disclosure causes a computer to execute, monitoring an operation of a network including a facility of an own company and a facility of another company, acquiring location attribute information of the facility, the location attribute information including at least an attribute indicating a facility manager of the facility, and determining a measure for recovering the facility based on the location attribute information in a case where a failure occurs in the facility.

According to an example advantage of the present disclosure, an operation monitoring device, an operation monitoring system, a method, and a program capable of quickly recovering a facility of another company even in a case where a device of the facility of the another company fails in a network including a facility of an own company and the facility of the another company can be provided.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an operation monitoring device according to the present disclosure;

FIG. 2 is a block diagram illustrating a state at the time of occurrence of failure according to the present disclosure;

FIG. 3 is a diagram illustrating a measure determination table according to the present disclosure;

FIG. 4 is a flowchart illustrating an operation of the operation monitoring device according to the present disclosure; and

FIG. 5 is a block diagram illustrating a hardware configuration of the

operation monitoring device according to the present disclosure.

### EXAMPLE EMBODIMENTS

Hereinafter, example embodiments of the present disclosure will be described with reference to the drawings. In the drawings, the same or corresponding elements are denoted by the same reference signs and redundant description will be omitted if necessary for clarity of description.

### Example Embodiment

### Outline

The data center business of communication carriers is expanding due to the spread of cloud services, the progress of digital transformation, and the like, but since capital investment is suppressed due to the stagnation of communication revenue, and the like, it is desired to construct a network using existing facilities of other companies. Therefore, the communication carrier needs to use not only the facility of the own company but also facilities of other companies. However, in a case where a device in the facility of another company fails, a recovery measure may be determined without considering a facility (location: place) in which the device is installed. In this case, even if a maintenance staff member goes to a facility of another company to replace a failed device, the maintenance staff member cannot enter the facility immediately and it takes time to perform the recovery work.

In order to solve the above problem, the present disclosure is characterized in that, in determination of a failure recovery measure, determination is performed in consideration of location attribute information (facility manager, entry-possible time, entry procedure, device stock status, access category) in addition to service failure related information. As a result, it is possible to make a comprehensive determination including conditions such as the installed facility of the failed device, the entry-possible time to the facility, the entry procedure, the stock status of the replacement device, and the like, and an optimal measure can be determined.

### Configuration

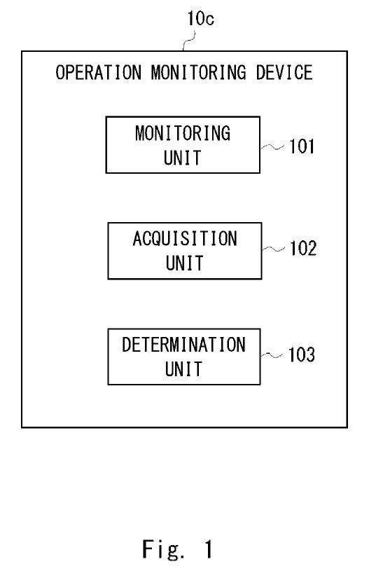

FIG. 1 is a block diagram illustrating a configuration of an operation monitoring device according to the present disclosure.

As illustrated in FIG. 1, an operation monitoring device 10c according to the present disclosure includes a monitoring unit 101, an acquisition unit 102, and a determination unit 103.

The monitoring unit 101 monitors operation of a network including a facility of a service company (own company) that operates a communication service and a facility of another company other than the own company.

The acquisition unit 102 acquires location attribute information of a facility. The location attribute information includes at least an attribute indicating a facility manager of the facility. The acquisition unit 102 may acquire the location attribute information of the facility in advance. Details of the location attribute information will be described later.

In a case where a failure occurs in the facility, for example, in a case where a device in the facility fails, the determination unit 103 determines a measure for recovering the facility based on the location attribute information. Details of the method for determining the measure will be described later.

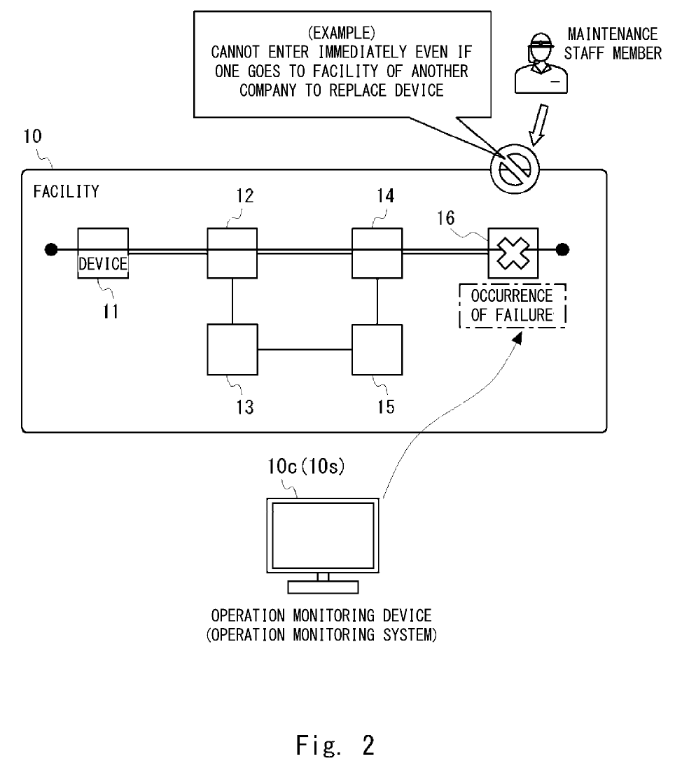

FIG. 2 is a block diagram illustrating a state at the time of occurrence of failure according to the present disclosure.

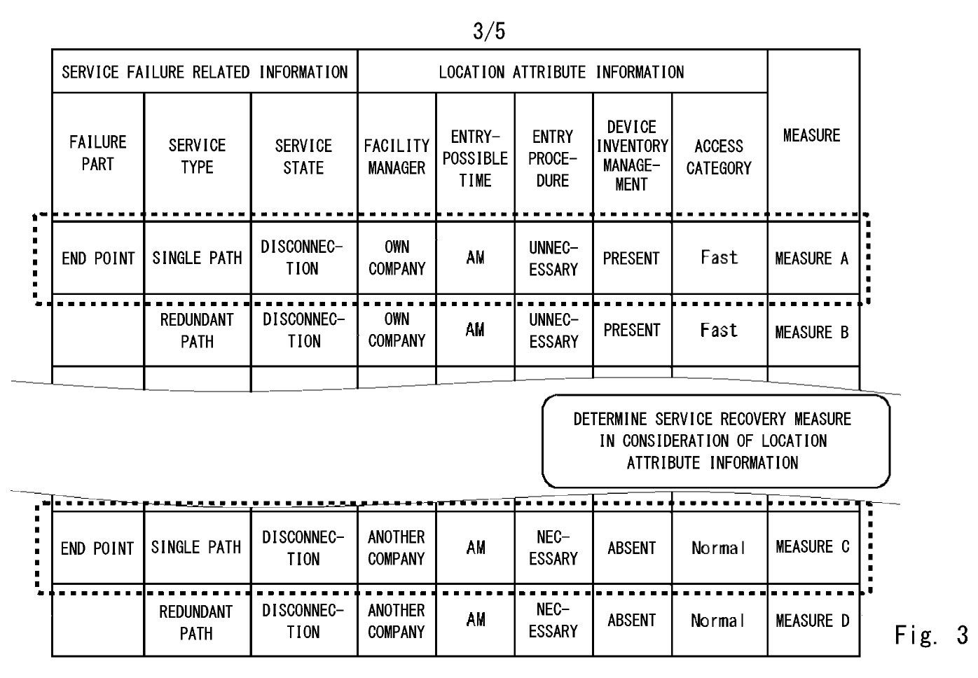

FIG. 3 is a diagram illustrating a measure determination table according to the present disclosure.

As illustrated in FIG. 2, a case where a failure of a device 16 occurred in the facility 10 will be considered. At this time, in a case where the facility of the device 16 is a facility of another company, the maintenance staff member of the communication carrier needs to replace the device 16. However, even if the

maintenance staff member goes to the facility of another company to replace the device 16, the maintenance staff member cannot enter the facility immediately because he/she is not a maintenance staff member of the own company, and thus it takes time for recovery work.

Therefore, as illustrated in FIG. 3, an operation monitoring device 10c acquires the location attribute information in advance as information necessary for going to the facility of another company. Then, in a case where a failure occurred in the facility and the attribute indicating the facility manager is of another company, the operation monitoring device 10c notifies the location attribute information to the facility of another company. As a result, since the facility of another company has acquired the location attribute information (entry-possible time, presence or absence of entry procedure, etc.) in advance, even if the maintenance staff member goes to the facility to replace the device 16, the maintenance staff member can enter the facility immediately.

As a result, the operation monitoring device capable of quickly recovering a facility of another company even in a case where a device of the facility of the another company fails in a network including a facility of the own company and the facility of the another company can be provided.

The measure determination table includes service failure related information, location attribute information, and a measure. The service failure related information includes information related to a failure site, a service type, and a service state. The location attribute information includes information related to a facility manager, an entry-possible time, an entry procedure, a device inventory management, and an access category. The measure determination table indicates a measure corresponding to a predetermined service and predetermined location attribute information.

In addition, in a case where a failure occurred in the facility and the attribute indicating the facility manager is of the own company, the operation monitoring device 10c may not notify the location attribute information to the

facility of the own company.

Furthermore, the facility 10 includes a device, but the device is, for example, an optical transmission device (optical transmission device) or a network device.

The facility manager of the location attribute information indicates whether the facility manager is of the own company or another company. The entry-possible time indicates a time at which the maintenance staff member can enter the facility, and is indicated as AM in the morning and indicated as PM in the afternoon. The entry-possible time may designate time or time slot at which the entrance is possible. The entry procedure indicates presence or absence of a procedure at the time of the maintenance staff member entering the facility. If the facility manager is from the own company, the entry procedure is unnecessary, and if the facility manager is from another company, the entry procedure is necessary. The device inventory management indicates the presence or absence of inventory of a device same as the failed device in the facility. In a case where there is a device same as the failed device, the maintenance staff member brings one from the stock for replacement. In a case where there is no device same as the failed device, the same device is ordered or the like. The access category indicates a movement time of the maintenance staff member of the communication carrier to the facility. The movement time is indicated by, for example, Fast, Normal, or Slow. The magnitude relationship of the movement time is Fast < Normal < Slow.

The location attribute information further includes, in addition to the attribute indicating the facility manager, at least one of an attribute indicating an entry-possible time to the facility, an attribute indicating presence or absence of a procedure at the time of entering the facility, an attribute indicating presence or absence of an inventory of a device in the facility, and an attribute (access category) indicating a movement time of the maintenance staff member to the facility (see FIG. 3).

In the example embodiment, the (service recovery) measure in consideration of the location attribute information can be determined by acquiring the location attribute information including the attribute indicating the facility manager of the facility. As a result, the maintenance staff member can smoothly enter the facility of another company, and the replacement work of the device 16 can be performed. As a result, the operation monitoring device capable of quickly recovering a facility of another company even in a case where a device of the facility of the another company fails in a network including a facility of the own company and the facility of the another company can be provided.

According to the example embodiment, since the operation monitoring device 10c manages the location attribute information, it is possible to select an optimal measure at the time of occurrence of a failure, and to quickly recover the service, so that improvement of the quality of service and reduction of the Operating Expense (OPEX) can be achieved.

The operation monitoring device 10c may further acquire the type of optical path used for the network, the failure location of the facility, and the information related to the failure of the facility. The optical path may be referred to as an optical communication path.

In addition, the operation monitoring device 10c may further include a storage unit for storing location attribute information.

### Operation

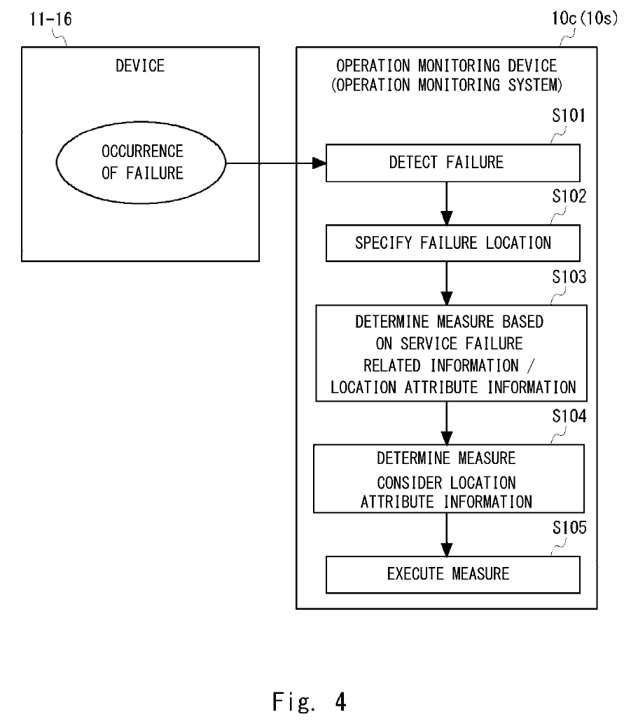

FIG. 4 is a flowchart illustrating an operation of the operation monitoring device according to the present disclosure.

As illustrated in FIG. 4, a case where a failure occurred in any of the devices 11 to 16 in the facility is considered. In this case, the operation monitoring device 10c detects a failure (step S101).

The operation monitoring device 10c specifies a failure location (step

S102).

The operation monitoring device 10c determines a measure based on the service failure related information/location attribute information (step S103). For example, the operation monitoring device 10c determines a measure that meets the condition of the failure in consideration of the location attribute information based on the measure determination table (table) illustrated in FIG. 3. The measure determination table includes at least location attribute information and a measure corresponding to the location attribute information. The measure determination table may be acquired in advance. The operation monitoring device 10c determines “measure A” as the measure in a case where the failure site in the measure determination table is “end point”, the service type is “single path”, the service state is “service disconnection”, the facility manager is “manager of own company”, the entry-possible time is “morning (AM)”, the entry procedure is “unnecessary”, the device inventory management is “inventory present”, and the access category is “Fast”.

Furthermore, the operation monitoring device 10c determines “measure C” as the measure in a case where the failure site is “end point”, the service type is “single path”, the service state is “service disconnection”, the facility manager is “manager of another company”, the entry-possible time is “morning (AM)”, the entry procedure is “necessary”, the device inventory management is “inventory absent”, and the access category is “Normal”.

The operation monitoring device 10c determines a measure in consideration of the location attribute information (step S104).

The operation monitoring device 10c executes the measure (step S105). For example, in a case of executing the measure C, the operation monitoring device 10c notifies the necessity of the entry procedure, the movement time of the maintenance staff member to the facility, and the like to the facility of another company.

According to the example embodiment, even if the information related to the failure is the same, a measure that takes into consideration the location attribute information can be determined. Then, the operation monitoring device 10c can automatically execute the recovery measure by performing the operations from step S101 to step S105. As a result, even in a case where a device of a facility of another company fails in a network including the facility of the own company and the facility of another company, a measure for quickly recovering the service of the facility can be executed.

That is, the operation monitoring device 10c can determine the recovery measure in consideration of the situation of the facility in which the device is installed by managing the location attribute information in which the device (optical transmission device) is installed.

In the example embodiment, the operation monitoring device 10c has been described as an example, but this is not the sole case. The example embodiment is also applicable to an operation monitoring system 10s including a facility of an own company, a facility of another company, and the operation monitoring device 10c. In this case, the facility of the own company in the operation monitoring system 10s has at least one or more devices for communication, and the facility of another company has at least one or more devices for communication. Then, the device in the facility of the own company and the device in the facility of another company communicate with each other.

### Hardware Configuration Example

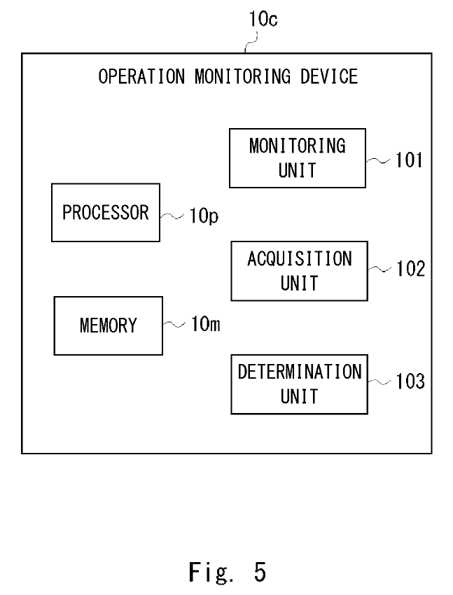

FIG. 5 is a block diagram illustrating a hardware configuration of the operation monitoring device according to the present disclosure.

As illustrated in FIG. 6, the operation monitoring device 10c includes at least one memory 10m for storing instructions and at least one processor 10p configured to process the instructions.

The instructions are as follows.

An operation of a network including a facility of an own company and a facility of another company is monitored, location attribute information of the facility is acquired, the location attribute information including at least an attribute indicating a facility manager of the facility, and in a case where a failure occurs in the facility, a measure for recovering the facility is determined based on the location attribute information.

In the above-described example embodiments, the present disclosure has been described as a hardware configuration, but the present disclosure is not limited thereto. The present disclosure can also implement processing of each component by causing a Central Processing Unit (CPU) to execute a computer program.

In the above example embodiment, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Moreover, while operations are illustrated in a specific order, this should not be understood as requiring that such operations be executed in the illustrated specific order or in a sequential order, or that all illustrated operations be executed, to achieve desirable results. In a specific situation, multitasking and

parallel processing may be advantageous. Similarly, while details of some specific example embodiments are included in the above discussion, these should be construed as descriptions of features specific to the specific example embodiments, rather than as limitations on the scope of the present disclosure. Specific features described in the context of separate example embodiments may be implemented in combination in a single example embodiment. Conversely, various features described in the context of a single example embodiment may be implemented in a plurality of example embodiments separately or in any appropriate combination.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The present disclosure is not limited to the above-described example embodiments, and can be appropriately changed without departing from the gist.

Some or all of the above example embodiments can also be described as the following Supplementary Notes, but are not limited to the following.

### Supplementary Note 1

An operation monitoring device including,

a monitoring unit for monitoring an operation of a network including a facility of an own company and a facility of another company,

an acquisition unit for acquiring location attribute information of the facility, the location attribute information including at least an attribute indicating a facility manager of the facility, and

a determination unit for determining a measure for recovering the facility based on the location attribute information in a case where a failure occurs in the facility.

### Supplementary Note 2

The operation monitoring device according to supplementary note 1, in which in a case where a failure occurs in the facility and the attribute indicating the facility manager is the another company, the determination unit notifies the location attribute information to the facility of the another company.

### Supplementary Note 3

The operation monitoring device according to supplementary note 1, in which the location attribute information further includes at least one of

an attribute indicating an entry-possible time to the facility,

an attribute indicating presence or absence of a procedure at the time of entering the facility,

an attribute indicating presence or absence of an inventory of a device in the facility, and

an attribute indicating a movement time of a maintenance staff member to the facility.

### Supplementary Note 4

The operation monitoring device according to supplementary note 1, in which the acquisition unit further acquires a type of an optical path used for the network, a failure location of the facility, and information regarding a failure of the facility.

### Supplementary Note 5

The operation monitoring device according to supplementary note 1, in which the facility includes an optical transmission device or a network device.

### Supplementary Note 6

The operation monitoring device according to supplementary note 1, further including a storage unit for storing the location attribute information.

### Supplementary Note 7

An operation monitoring system including a facility of an own company, a facility of another company, and an operation monitoring device, in which

the facility of the own company includes at least one or more devices for communication,

the facility of the another company includes at least one or more of the devices for communication,

the device in the facility of the own company and the device in the facility of the another company communicate with each other, and

the operation monitoring device includes,

a monitoring unit for monitoring an operation of a network including the facility of the own company and the facility of the another company,

an acquisition unit for acquiring location attribute information of the facility, the location attribute information including at least an attribute indicating a facility manager of the facility, and

a determination unit for determining a measure for recovering the facility based on the location attribute information in a case where a failure occurs in the facility.

### Supplementary Note 8

The operation monitoring system according to supplementary note 7, in which in a case where a failure occurs in the facility and the attribute indicating the facility manager is the another company, the determination unit notifies the location attribute information to the facility of the another company.

### Supplementary Note 9

A method executed by an operation monitoring device, the method including,

monitoring an operation of a network including a facility of an own company and a facility of another company,

acquiring location attribute information of the facility, the location attribute information including at least an attribute indicating a facility manager of the facility, and

determining a measure for recovering the facility based on the location attribute information in a case where a failure occurs in the facility.

### Supplementary Note 10

A program for causing a computer to execute,

monitoring an operation of a network including a facility of an own company and a facility of another company,

acquiring location attribute information of the facility, the location attribute information including at least an attribute indicating a facility manager of the facility, and

determining a measure for recovering the facility based on the location attribute information in a case where a failure occurs in the facility.

### Supplementary Note 11

An operation monitoring device including

at least one memory stored with instructions, and

at least one processor configured to process the instructions, in which the instructions

monitor an operation of a network including a facility of an own company and a facility of another company,

acquire location attribute information of the facility, the location attribute information including at least an attribute indicating a facility manager of the facility, and

determine a measure for recovering the facility based on the location attribute information in a case where a failure occurs in the facility.

### Supplementary Note 12

The operation monitoring device according to supplementary note 1, in which in a case where a failure occurs in the facility and the attribute indicating the facility manager is the own company, the determination unit does not notify the location attribute information to the facility of the own company.

### Supplementary Note 13

The operation monitoring device according to supplementary note 1, in

which the determination unit determines the measure that meets conditions of the failure based on a measure determination table including at least the location attribute information and the measure related to the location attribute information.

What is claimed is:

1. An operation monitoring device comprising: at least one memory stored with instructions; and at least one processor configured to execute the following instructions, the at least one processor being coupled to the memory, the instructions including monitoring an operation of a network including a facility of an own company and a facility of another company; acquiring location attribute information of the facility, the location attribute information including at least an attribute indicating a facility manager of the facility; and determining a measure for recovering the facility based on the location attribute information in a case where a failure occurs in the facility.

2. The operation monitoring device according to claim 1, wherein the at least one processor is further configured to execute the following instructions: notifying, in a case where a failure occurs in the facility and the attribute indicating the facility manager is the another company, the location attribute information to the facility of the another company.

3. The operation monitoring device according to claim 1, wherein the location attribute information further includes at least one of an attribute indicating an entry-possible time to the facility, an attribute indicating presence or absence of a procedure at the time of entering the facility, an attribute indicating presence or absence of an inventory of a device in the facility, and an attribute indicating a movement time of a maintenance staff member to the facility.

4. The operation monitoring device according to claim 1, wherein the at least one processor is further configured to execute the following instructions: further acquiring a type of an optical path used for the network, a failure location of the facility, and information regarding a failure of the facility.

5. The operation monitoring device according to claim 1, wherein the facility includes an optical transmission device or a network device.

6. The operation monitoring device according to claim 1, further including a storage unit for storing the location attribute information.

7. The operation monitoring device according to claim 1, wherein the at least one processor is further configured to execute the following instructions: not notifying, in a case where a failure occurs in the facility and the attribute indicating the facility manager is the own company, the location attribute information to the facility of the own company.

8. The operation monitoring device according to claim 1, wherein the at least one processor is further configured to execute the following instructions: determining the measure that meets conditions of the failure based on a measure determination table including at least the location attribute information and the measure related to the location attribute information.

9. An operation monitoring system comprising a facility of an own company, a facility of another company, and an operation monitoring device, wherein the facility of the own company includes at least one or more devices for communication, the facility of the another company includes at least one or more of the devices for communication, the device in the facility of the own company and the device in the facility of the another company communicate with each other, and the operation monitoring device includes, at least one memory stored with instructions, and at least one processor configured to execute the following instructions the at least one processor being coupled to the memory, the instructions including monitoring an operation of a network including a facility of an own company and a facility of another company, acquiring location attribute information of the facility, the location attribute information including at least an attribute indicating a facility manager of the facility, and determining a measure for recovering the facility based on the location attribute information in a case where a failure occurs in the facility.

10. The operation monitoring system according to claim 9, wherein the at least one processor is further configured to execute the following instructions: notifying, in a case where a failure occurs in the facility and the attribute indicating the facility manager is the another company, the location attribute information to the facility of the another company.

11. A method executed by an operation monitoring device, the method including, monitoring an operation of a network including a facility of an own company and a facility of another company; acquiring location attribute information of the facility, the location attribute information including at least an attribute indicating a facility manager of the facility; and determining a measure for recovering the facility based on the location attribute information in a case where a failure occurs in the facility.

12. The method according to claim 11, further comprising notifying, in a case where a failure occurs in the facility and the attribute indicating the facility manager is the another company, the location attribute information to the facility of the another company.

13. The method according to claim 11, wherein the location attribute information further includes at least one of an attribute indicating an entry-possible time to the facility, an attribute indicating presence or absence of a procedure at the time of entering the facility, an attribute indicating presence or absence of an inventory of a device in the facility, and an attribute indicating a movement time of a maintenance staff member to the facility.

14. The method according to claim 11, further comprising acquiring a type of an optical path used for the network, a failure location of the facility, and information regarding a failure of the facility.

15. The method according to claim 11, wherein the facility includes an optical transmission device or a network device.

16. The method according to claim 11, further comprising storing the location attribute information.

17. The method according to claim 11, further comprising not notifying, in a case where a failure occurs in the facility and the attribute indicating the facility manager is the own company, the location attribute information to the facility of the own company.

18. The method according to claim 11, further comprising determining the measure that meets conditions of the failure based on a measure determination table including at least the location attribute information and the measure related to the location attribute information.
